(19) United States
(12) Patent Application Publication
(10) Pub. No.: US 2025/0189413 A1
(43) Pub. Date: Jun. 12, 2025

(54) BIOLOGICAL SAMPLE PREPARATION METHOD, BIOLOGICAL SAMPLE PREPARATION APPARATUS, TARGET SUBSTANCE IDENTIFICATION METHOD AND TARGET SUBSTANCE IDENTIFICATION APPARATUS

(71) Applicant: CANON KABUSHIKI KAISHA, Tokyo (JP)

(72) Inventors: MASARU SUGITA, Tokyo (JP); AKIKO TOMINAGA, Kanagawa (JP); TAKESHI OTA, Kanagawa (JP); KOUICHIROU OCHI, Chiba (JP)

(21) Appl. No.: 18/977,093

(22) Filed: Dec. 11, 2024

(30) Foreign Application Priority Data
Dec. 12, 2023 (JP) 2023-209048
Nov. 29, 2024 (JP) 2024-208094

(51) Int. Cl. G01N 1/28

(52) U.S. Cl. CPC G01N 1/28

(57) ABSTRACT

A method of preparing a biological sample for an assay includes determining a contour of the biological sample on a substrate, using an ink jet liquid ejection head to form a holding portion for holding at least part of the reaction solution inside the contour on the substrate along the contour, and applying the reaction solution to the biological sample to obtain the biological sample for the assay.

### BACKGROUND OF THE DISCLOSURE

### Field of the Disclosure

The present disclosure relates to a method of preparing a biological sample for an assay, a biological sample preparation apparatus for an assay, a method for identifying a target substance in a biological sample and a target substance identification apparatus.

### Description of the Related Art

In pathology, tests related to a disease are performed to find causes of the disease. Detection of a target substance by staining with a dye, such as hematoxylin and eosin (HE) staining, immunohistochemistry, and staining in in situ hybridization, is often necessary in pathology as an important test to determine a therapeutic strategy. In a pathological test, a sample is prepared by attaching a cell or tissue piece extracted from a living body to a substrate, such as a glass slide. Then, the sample is brought into contact with a predetermined detection solution to stain the cell or tissue piece to perform a detection of a target substance.

Detection solutions used in pathological tests are expensive. Particularly, antibodies used in immunohistochemistry and probes used in in situ hybridization are very expensive, so that detection solutions containing such antibodies or probes are often used in small amounts. For this reason, there is a demand to place a detection solution accurately on a biological sample containing a target substance to be stained and to maintain the state as long as possible.

As a measure to resolve this issue, there is known a pen (peroxidase-antiperoxidase (PAP) pen) that forms a water-repellent frame on a glass slide. A water-repellent frame is formed using a PAP pen to surround a biological sample placed on a glass slide, and a detection solution is applied inside the frame. Thus, staining can be carried out efficiently with a small amount of the detection solution by preventing the detection solution from moving to an area there is no staining target.

However, a user forms a water-repellent frame by hand using a peroxidase-antiperoxidase (PAP) pen, so that it is difficult to create a precise frame, making it difficult to further reduce an amount of a detection solution (hereinbelow, also referred to as a “reaction solution”) to be applied.

Japanese Patent Application Laid-Open No. 2006-105653 discusses a tissue staining sheet having through-holes that form separate compartments. It is disclosed that a plurality of compartments is formed on a glass slide by closely contacting the tissue staining sheet with the glass slide to prevent an antibody and a probe from flowing out to other compartments.

According to the tissue staining sheet discussed in Japanese Patent Application Laid-Open No. 2006-105653, shapes and sizes of through-holes for forming compartments are determined in advance. Thus, the shapes and sizes of through-holes cannot be changed to fit a biological sample, making it difficult to further reduce an amount of a reaction solution applied.

### SUMMARY OF THE DISCLOSURE

The present disclosure is directed to the provision of a method of preparing a biological sample for an assay that can reduce an amount of a reaction solution applied to identify the target substance in a biological sample, a biological sample preparation apparatus for an assay, a method for identifying a target substance, and a target substance identification apparatus.

According to an aspect of the present disclosure, a method of preparing a biological sample for an assay includes determining a contour of the biological sample on a substrate, forming a holding portion along the contour using an ink jet liquid ejection head for holding at least part of a reaction solution containing a compound capable of specifically binding to a target substance in the biological sample inside the contour on the substrate, and applying the reaction solution to the biological sample to obtain the biological sample for the assay.

According to an aspect of the present disclosure, a biological sample preparation apparatus for an assay includes a contour determination unit configured to determine a contour of the biological sample on a substrate, a liquid ejection unit including an ink jet liquid ejection head configured to form a holding portion for holding at least part of a reaction solution containing a compound capable of specifically binding to a target substance in the biological sample inside the contour on the substrate along the contour, and a reaction solution application unit configured to apply the reaction solution to the biological sample to obtain the biological sample for the assay.

According to an aspect of the present disclosure, a method for identifying a target substance in a biological sample includes determining a contour of the biological sample on a substrate, forming a holding portion along the contour using an ink jet liquid ejection head for holding at least part of a reaction solution containing a compound capable of specifically binding to a target substance in the biological sample inside the contour on the substrate, applying the reaction solution to the biological sample, and identifying the target substance by detecting the compound bound to the target substance.

Further, according to another aspect of the present disclosure, a target substance identification apparatus that identifies a target substance in a biological sample includes a contour determination unit configured to determine a contour of the biological sample on a substrate, a liquid ejection unit including an ink jet liquid ejection head configured to form a holding portion for holding at least part of a reaction solution containing a compound capable of specifically binding to a target substance in the biological sample inside the contour on the substrate along the contour, a reaction solution application unit configured to apply the reaction solution to the biological sample, and an identification unit configured to detect the compound bound to the target substance.

Further features of the present disclosure will become apparent from the following description of exemplary embodiments with reference to the attached drawings.

### BRIEF DESCRIPTION OF THE DRAWINGS

FIG. 1 is a schematic diagram illustrating an exemplary embodiment of a biological sample preparation apparatus according to the present disclosure.

FIGS. 2A to 2C are schematic diagrams illustrating each process in an exemplary embodiment of a biological sample preparation method according to the present disclosure.

FIG. 3 is a cross-sectional view of a biological sample on a substrate with a partition wall formed as a holding portion.

### DESCRIPTION OF THE EMBODIMENTS

The present disclosure will be described in detail in exemplary embodiments. According to exemplary embodiments of the present disclosure, in the case of a salt as a compound, the salt is present in a reaction solution or liquid composition in a form of a dissociated ion, which is referred to as “a salt is contained” for convenience sake. Further, unless otherwise determined, physical property values are values at room temperature (25° C.).

The inventors studied formation of a holding portion for holding a reaction solution on a substrate in order to reduce an amount of the reaction solution applied to identify a target substance in a biological sample.

As a result, the inventors have discovered that it is important to determine the contour of a biological sample on a substrate and then form a holding portion along the contour using an ink jet liquid ejection head, and have achieved the present disclosure.

According to the present disclosure, the contour of a biological sample on a substrate is first determined. Then, based on information about the determined contour, a holding portion is formed on the substrate along the contour of the biological sample using an ink jet liquid ejection head. Since the contour of the biological sample is previously determined, a holding portion that matches each of the contours of biological samples, even if different from each other, can be formed. Further, an ink jet liquid ejection head is used to form a holding portion, which allows a holding portion to be formed with precision. This prevents an applied reaction solution from moving to an area where the biological sample is not present on the substrate due to wetting and spread and enables the amount of the reaction solution that is not involved in identifying a target substance to be reduced as much as possible based on the contour of the biological sample. As a result, even if the amount of a reaction solution applied is reduced to its minimum to identify a target substance, the target substance in a biological sample can be adequately identified.

### <<Biological Sample Preparation Method, Biological Sample Preparation Apparatus, Target Substance Identification Method, and Target Substance Identification Apparatus>>

A biological sample preparation method according to the present disclosure (hereinbelow, also simply referred to as a “preparation method”) includes the following three processes: (a1) a process for determining the contour of a biological sample on a substrate; (b1) a process for using an ink jet liquid ejection head to form a holding portion for holding at least part of a reaction solution containing a compound capable of specifically binding to a target substance in the biological sample inside the contour on the substrate along the contour; and (c1) a process for applying the reaction solution to the biological sample to obtain the biological sample for the assay.

A biological sample preparation apparatus according to the present disclosure (hereinbelow, also simply referred to as a “preparation apparatus”) includes the following three units: (A1) a contour determination unit configured to determine the contour of a biological sample on a substrate; (B1) a liquid ejection unit including an ink jet liquid ejection head configured to form a holding portion for holding at least part of a reaction solution containing a compound capable of specifically binding to a target substance in the biological sample inside the contour on the substrate along the contour; and (C1) a reaction solution application unit configured to apply the reaction solution to the biological sample to obtain the biological sample for the assay.

A target substance identification method according to the present disclosure (hereinbelow, also simply referred to as an “identification method”) includes the following four processes: (a2) a process for determining the contour of a biological sample on a substrate; (b2) a process for using an ink jet liquid ejection head to form a holding portion for holding at least part of a reaction solution containing a compound capable of specifically binding to a target substance in the biological sample inside the contour on the substrate along the contour; (c2) a process for applying the reaction solution to the biological sample; and (d2) a process for identifying the target substance by detecting the compound bound to the target substance.

Further, a target substance identification apparatus according to an exemplary embodiment of the present disclosure (hereinbelow, also simply referred to as an “identification apparatus”) includes the following four units: (A2) a contour determination unit configured to determine the contour of a biological sample on a substrate; (B2) a liquid ejection unit including an ink jet liquid ejection head configured to form a holding portion for holding at least part of a reaction solution containing a compound capable of specifically binding to a target substance in the biological sample inside the contour on the substrate along the contour; (C2) a reaction solution application unit configured to apply the reaction solution to the biological sample; and (D2) an identification unit configured to detect the compound bound to the target substance. The biological sample preparation method has a substantially similar configuration to the target substance identification method except for not including (d2) a process for identifying the target substance by detecting the compound bound to the target substance. In addition, the biological sample preparation apparatus has a substantially similar configuration to the target substance identification apparatus except for not including (D2) an identification unit configured to detect the compound bound to the target substance.

### <Biological Sample Preparation Apparatus>

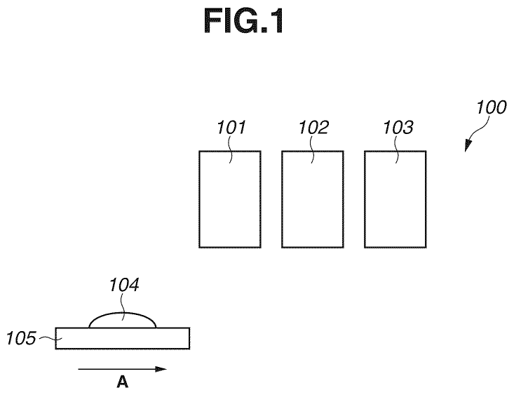

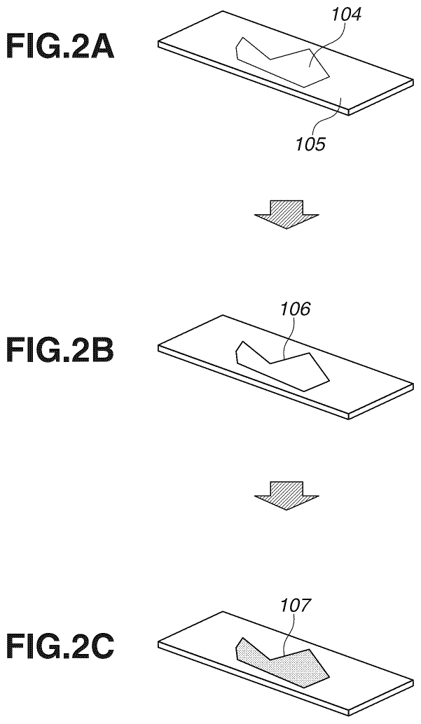

The biological sample preparation apparatus will be described with reference to the attached drawings. FIG. 1 is a schematic diagram illustrating an exemplary embodiment of the preparation apparatus according to the present disclosure. FIGS. 2A to 2C illustrate processes in an exemplary embodiment of the preparation method used in the exemplary embodiment of the preparation apparatus. A preparation apparatus 100 according to the present exemplary embodiment includes a contour determination apparatus 101 serving as a contour determination unit, a liquid ejection apparatus 102 serving as a liquid ejection unit, and a reaction solution application apparatus 103 serving as a reaction solution application unit. A substrate 105 carrying a biological sample 104 thereon is conveyed in the direction of an arrow A by a conveyance apparatus (not illustrated). The conveyance apparatus can be included in the preparation apparatus 100 or can exist as a separate apparatus from the preparation apparatus 100.

The contour determination apparatus 101 is located above the substrate 105 and determines the contour of the biological sample 104 on the substrate 105 (FIG. 2A). The liquid ejection apparatus 102 includes an ink jet liquid ejection head. Then, the liquid ejection apparatus 102 forms a holding portion 106 for holding at least part of a reaction solution inside the contour on the substrate 105 along the contour based on information regarding the contour of the biological sample 104 determined by the contour determination apparatus 101 (FIG. 2B). After the holding portion 106 is formed by the liquid ejection apparatus 102, the reaction solution application apparatus 103 applies a reaction solution 107 to the biological sample 104 surrounded by the holding portion 106 to cause a compound contained in the reaction solution 107 to bind to a target substance (FIG. 2C). This process enables the target substance in the biological sample 104 to be brought into a detectable state, allowing the target substance to be identified. Namely, a biological sample for an assay can be obtained. FIG. 1 illustrates an example in which the substrate 105 is conveyed by the conveyance apparatus, but the substrate 105 can be fixed. With the substrate 105 fixed, the contour determination apparatus 101, the liquid ejection apparatus 102, and the reaction solution application apparatus 103 are each further provided with the conveyance apparatus and are in a movable state. Then, with the contour determination apparatus 101, the liquid ejection apparatus 102, and the reaction solution application apparatus 103 being moved, the contour of the biological sample 104 is determined, the holding portion 106 is formed, and the reaction solution 107 is applied.

Constituents of the biological sample preparation apparatus will now be described.

### [Contour Determination Apparatus]

The biological sample 104 on the substrate 105 often does not have a fixed shape, such as a rectangle or a circle, calling for an accurate determination of its contour. For this reason, the contour determination apparatus 101 is used to determine the contour of the biological sample 104. The contour determination apparatus 101 is not particularly limited to thereto as long as the contour determination apparatus can determine the contour of the biological sample 104. In particular, it is desirable that the contour determination apparatus 101 optically determine the contour of the biological sample 104. Specifically, it is desirable to optically distinguish the biological sample 104 from its surrounding air. Examples of the contour determination apparatus that optically determines a contour include known apparatuses, such as an image capturing apparatus including a lens, and a sensor that uses optical reflection. It is desirable that the contour determination apparatus 101 be provided in the preparation apparatus 100 so as to perform scanning to determine the contour of a biological sample in a wide range.

Data regarding the contour of the biological sample 104 acquired by the contour determination apparatus 101 is transmitted to the liquid ejection apparatus 102. The method for transmitting the data regarding the contour to the liquid ejection apparatus 102 is not limited thereto, and a known method can be used. For example, an electrical unit can be used to transmit data regarding a contour to a computer, and the computer can convert the data into data regarding ejection patterning in forming the holding portion 106 using the liquid ejection apparatus 102 and transmit the converted data to the liquid ejection apparatus 102.

### [Biological Sample]

Examples of biological samples include a cultured cell, an animal body fluid (e.g., blood, serum, plasma, spinal fluid, sweat, saliva, and urine), hair, excrement, an organ, a tissue, an animal or a plant itself, samples of these fixed and then embedded in paraffin, or dried samples.

### [Substrate]

In pathological staining, a thinly sliced biological sample is often placed on a glass slide as a substrate, and then cell staining is performed. According to the exemplary embodiment of the present disclosure, the substrate is not limited to a glass slide. Specifically, examples of substrates include a glass slide, paper, a plastic, a metal, a rubber, and a ceramic.

### [Liquid Ejection Apparatus]

The liquid ejection apparatus 102 includes an ink jet liquid ejection head. Then, the liquid ejection apparatus 102 forms the holding portion 106 for holding the reaction solution based on the data regarding the contour of the biological sample 104 acquired by the contour determination apparatus 101. By using the ink jet liquid ejection head, the liquid ejection apparatus 102 can apply a liquid composition for forming a holding portion (hereinbelow, also simply referred to as a liquid composition) in an amount at the level of picoliters, allowing the formation of the holding portion 106 with precision along the contour of a biological sample. It is sufficient that the holding portion 106 is formed to be able to hold at least part of the reaction solution inside the contour. Thus, the liquid composition does not necessarily have to be solidified on the substrate after being applied on the substrate. For example, it is sufficient that the holding portion formed of the liquid composition is in a state where the holding portion can hold the reaction solution inside the contour of the biological sample and does not move in its position so that the target substance can be accurately identified by increasing the viscosity of the liquid composition even if it is not solidified. Examples of the ink jet liquid ejection head include a form that ejects liquid by causing film boiling in the liquid and forming bubbles using an electrothermal converter, a form that ejects liquid using an electromechanical converter, and a form that ejects liquid using static electricity. According to the present disclosure, a known ink jet liquid ejection head can be used. In particular, a liquid ejection head that uses an electrothermal converter is desirable from the viewpoint of ejecting liquid with high speed and high density. The ink jet liquid ejection head receives an image signal corresponding to the shape of the holding portion and can apply the required amount of the liquid composition to each position. Further, the liquid ejection apparatus 102 can also be provided with a cap or the like to reduce the evaporation of the liquid composition from an ejection port of the liquid ejection head in addition to the liquid ejection head.

As long as the holding portion 106 is formed along the contour of the biological sample 104, the holding portion 106 does not necessarily have to be formed to come into contact with the contour of the biological sample 104. However, in terms of reducing the amount of the reaction solution applied, it is desirable that the holding portion 106 be formed to come into contact with the contour of the biological sample 104. The holding portion 106 can be formed in a form of discontinuous dots, but in terms of reducing the amount of the reaction solution applied, it is desirable that the holding portion 106 be formed continuously to cover (surround) the periphery of the contour of the biological sample 104. In the present determination, the holding portion 106 formed continuously covering the periphery of the contour of the biological sample 104 is also referred to as a partition wall.

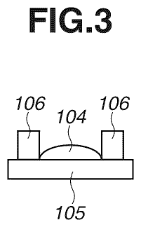

The holding portion 106 is desirably a partition wall that partitions the space for holding the reaction solution inside the contour of the biological sample 104. FIG. 3 is a cross-sectional view of the biological sample 104 on the substrate 105 with a partition wall formed as the holding portion 106. As illustrated in FIG. 3, it is desirable that the holding portion 106 be a partition wall having a predetermined height, so that the partition wall can hold more reaction solution inside the contour of the biological sample 104, making it easier for the reaction solution to come into contact with the target substance in the biological sample 104. The height of the partition wall is not so particularly limiting, but as illustrated in FIG. 3, it is desirable that the minimum height of the partition wall from the surface of the substrate 105 be greater than the maximum height of the biological sample 104 from the surface of the substrate 105, making it more easily to hold the reaction solution inside the contour of the biological sample 104.

### [Liquid Composition]

The holding portion 106 is formed of the liquid composition applied by the liquid ejection apparatus 102.

### (Thickening Component)

The liquid composition applied by the liquid ejection apparatus 102 to form the holding portion 106 desirably contains a thickening component that thickens by a reaction after being applied to the substrate. This allows the liquid composition applied to the substrate be thickened to form the holding portion 106 precisely along the contour of the biological sample 104 on the substrate as illustrated in FIGS. 2A to 2C and 3. Further, the partition wall that continuously covers the periphery of the contour of the biological sample 104 and has a constant height can also be formed. As a result, even with low surface tension of the reaction solution or an increased amount of the reaction solution, the reaction solution can be held inside the partition wall. In addition, a cross-linked structure cab be formed by this reaction. A cross-linked structure makes it easier to reduce the dissolution by the reaction liquid applied in a next step and the effect of reactivity of the reaction solution on the target substance. In addition to the thickening component thickening the holding portion 106, the holding portion 106 can be also solidified.

The reaction of the liquid composition can be caused by a method for applying energy, such as light or heat, or a method for applying a different type of liquid composition, after the liquid composition is applied to the substrate. Among them, it is desirable that the holding portion 106 be formed in such a manner that uses a plurality of liquid ejection heads to each eject liquid composition containing a different type of constituent material of the holding portion to the substrate to cause the different types of liquid composition to come into contact with each other thereon. Particularly, it is desirable that the constituent materials of the holding portion contained in the liquid composition include a thickening component that can thicken by two different types of liquid composition coming into contact with each other.

The thickening component desirably includes a component causing at least one interaction selected from a group including an electrostatic interaction, a hydrophobic interaction, and the formation of a hydrogen bond. Among them, it is particularly desirable that the thickening component be an ionic component that can cause an electrostatic interaction. With an ionic component used as a thickening component, it is desirable that different ionic components (a cationic component and an anionic component) be each contained in the corresponding type of the two types of liquid composition (first liquid composition and second liquid composition), making it possible to improve storage stability and the application property of the liquid composition. The ionic component desirably contains at least one selected from a group including a polyvalent metal salt, an organic acid, and an ionic resin, and more desirably contains an ionic resin. Examples of the ionic resin include a cationic resin and an anionic resin. The liquid composition is desirably the first liquid composition containing a polyvalent metal salt, an organic acid, a cationic resin, or an anionic resin and the second liquid composition containing a cationic resin or an anionic resin, and more desirably the first liquid composition containing a cationic resin and the second liquid composition containing an anionic resin. The liquid composition contains a thickening component, increasing the viscosity of mixed liquid acquired by the two types of liquid composition coming into contact with each other, which prevents the mixed liquid from spreading on the substrate. This allows the holding portion with precision to be formed, and various types of reaction solutions to be applied to a single sample. In addition, the reaction solution is prevented from flowing out to a portion without an identification target, providing effective use of the reaction solution.

A liquid composition containing an organic acid has a buffering capacity in the acidic range (less than pH 7.0, desirably pH 2.0 to 5.0), and thus the anionic component present in the other liquid composition is efficiently converted into its acid form and aggregated. Examples of organic acids include monocarboxylic acids, such as formic acid, acetic acid, propionic acid, butyric acid, benzoic acid, glycolic acid, lactic acid, salicylic acid, pyrrole carboxylic acid, furan carboxylic acid, picolinic acid, nicotinic acid, thiophene carboxylic acid, levulinic acid, and coumaric acid and salts thereof, dicarboxylic acids, such as oxalic acid, malonic acid, succinic acid, glutaric acid, adipic acid, maleic acid, fumaric acid, itaconic acid, sebacic acid, phthalic acid, malic acid, and tartaric acid and salts and hydrogen salts thereof, tricarboxylic acids, such as citric acid and trimellitic acid, and salts and hydrogen salts thereof, and tetracarboxylic acids, such as pyromellitic acid, and salts and hydrogen salts thereof. The content (mass %) of an organic acid in the liquid composition is desirably 1.0 mass % or more and 5.0 mass % or less based on the total mass of the liquid composition.

A polyvalent metal salt is a compound formed of a divalent or higher valent metal ion (polyvalent metal ion) and an anion. A polyvalent metal salt dissociates in a liquid composition to become a polyvalent metal ion which aggregates the anionic component in the other liquid composition. A polyvalent metal salt can be a hydrate. Examples of polyvalent metal ions contained in polyvalent metal salts include divalent metal ions, such as Ca²⁺, Cu²⁺, Ni²⁺, Mg²⁺, Sr²⁺, Ba²⁺, and Zn²⁺, and trivalent metal ions, such as Fe³⁺, Cr³⁺, Y³⁺, and Al³⁺. Examples of anions include inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻, and H₂PO₄⁻, and organic anions, such as HCOO⁻, (COO⁻)₂, COOH(COO⁻), CH₃COO⁻, C₂H₅COO⁻, CH₃CH(OH)COO⁻, C₂H₄(COO⁻)₂, C₆H₅COO—, C₆H₄(COO⁻)₂, and CH₃SO₃⁻. The content (mass %) of the polyvalent metal salt equivalent in a liquid composition is desirably between 1.0 mass % and 20.0 mass % based on the total mass of the liquid composition.

Among the ionic resins, examples of the cationic resins include resins having a primary, secondary, or tertiary amine structure, and resins having a quaternary ammonium salt structure. Examples of the cationic resins include resins having structures, such as vinylamine, allylamine, vinylimidazole, vinylpyridine, dimethylaminoethyl methacrylate, ethyleneimine, guanidine, diallyldimethylammonium chloride, and alkylamine-epichlorohydrin condensates. In order to enhance the dissolubility in a liquid composition, a cationic resin can be used in combination with an acidic compound, or be subjected to a quaternary treatment. With a cationic resin added, the content (mass %) of the cationic resin in a liquid composition is desirably between 0.1 mass % and 10.0 mass % based on the total mass of the liquid composition.

Among the ionic resins, examples of the anionic resins include resins having an anionic group, such as a carboxylic acid group, a sulfonic acid group, and a phosphonic acid group. Examples can include acrylic acid-based resins and urethane-based resins having these anionic groups. With an anionic resin added, the content (mass %) of the anionic resin in a liquid composition is desirably between 0.1 mass % and 10.0 mass % based on the total mass of the liquid composition.

Both the first liquid composition and the second liquid composition can be applied to the substrate before the reaction solution is applied thereto. Further, there is no particular limitation on the order in which the first liquid composition and the second liquid composition are applied to the substrate.

With a polyvalent metal salt or an organic acid used as the thickening component, it is desirable to increase the concentration of the thickening component in the second liquid composition with respect to the hydrophobic component in the first liquid composition or to increase the amount of the second liquid composition applied. This facilitates increase of the viscosity of the mixed liquid of the first liquid composition and the second liquid composition, allowing the holding portion to be efficiently formed. In this case, the amount of the thickening component applied with the second liquid composition is within a range that does not affect the biological sample or the reaction solution.

With a cationic resin or an anionic resin used as the thickening component, it is desirable to apply the first liquid composition and the second liquid composition so that the thickening component in the first liquid composition and the thickening component in the second liquid composition are in an appropriate ratio. This provides quick increase in the viscosity of the mixed liquid, allowing the holding portion to be efficiently formed.

With a cationic resin and an anionic resin used as the thickening components contained in the first liquid composition and the second liquid composition, respectively, the appropriate ratio can be calculated from the amine value of the cationic resin and the acid value of the anionic resin.

Further, a ratio at which the viscosity can be most effectively increased can be experimentally found by mixing at different ratios of the application amount of the first liquid composition to the application amount of the second liquid composition and then measuring the viscosities of the mixed liquids.

### (Hydrophobic Component)

The liquid composition desirably has a composition having surface tension different from that of the reaction solution. When the reaction solution is aqueous, it is desirable that the liquid composition contains a hydrophobic component as a constituent material of the holding portion. When the liquid composition is aqueous, it is desirable that hydrophilicity be imparted to the hydrophobic component contained in the liquid composition for the hydrophobic component to be dissolved or dispersed in the aqueous liquid composition for use.

There is no particular limitation on the hydrophobic component contained in the liquid composition as long as the hydrophobic component has water repellency with the holding portion formed. Specifically, the hydrophobic component is desirably at least one selected from a group including an alkyl ketene dimer, an alkenyl succinic acid anhydride, rosin, wax, and ionic resins, such as a cationic resin and an anionic resin. As described above, the cationic resin and the anionic resin can also have a function as a thickening component.

### (Aqueous Medium)

The liquid composition desirably contains an aqueous medium. An aqueous medium similar to an aqueous medium contained in a reaction solution described below can be used.

### (Water-Soluble Resin)

The liquid composition desirably contains a water-soluble resin. A water-soluble resin refers to a resin that can be dissolved in water. The solubility of the water-soluble resin in water at 25° C. is desirably 1 mass % or more. Further, a water-soluble organic solvent can be added to water to increase the solubility of the water-soluble resin to dissolve the water-soluble resin in the aqueous medium for use. When the liquid composition further contains a water-soluble resin, the above-described constituent materials of the holding portion and the water-soluble resin are mixed in the liquid composition. In this state, the first liquid composition and the second liquid composition come into contact with each other on the substrate, so that the constituent materials of the holding portion and the water-soluble resin combine and aggregate to quickly increase the viscosity, allowing the holding portion to be formed with precision. Thus, the water-soluble resin contained in the liquid composition desirably has a property that contributes to the increase in viscosity when the two different types of liquid composition are mixed.

On the other hand, when the liquid composition contains an excessive amount of the water-soluble resin, the water repellency of the holding portion may be decreased. Thus, the content of the water-soluble resin in the liquid composition has an appropriate range. An appropriate range of the content of the water-soluble resin in the liquid composition can be determined such that improvement of viscosity increase efficiency and reduction of the decrease in water repellency are both achieved through a previous consideration of relative content ratios in the liquid composition to constituent materials of the holding portion contained therein with the water-soluble resin.

The water-soluble resin is desirably at least one selected from a group particularly including an anionic water-soluble resin and a cationic water-soluble resin.

### (Other Components)

In addition to the above-described components, the liquid composition can contain various additives, as appropriate, such as a defoaming agent, a surface active agent, a pH adjuster, a viscosity modifier, a rust-preventing agent, an antiseptic agent, a mildew-proofing agent, an antioxidant, and a reduction inhibitor. Further, in order to make the holding portion more visible, a coloring material, such as a pigment and a dye, can be used as an additive as appropriate.

### [Reaction Solution Application Apparatus]

There is no particular limitation on the reaction solution application apparatus as long as the reaction solution application apparatus can apply a reaction solution containing a compound capable of specifically binding to a target substance in a biological sample to the biological sample, and a known reaction solution application apparatus can be used. In particular, it is desirable that the reaction solution application apparatus include an ink jet liquid ejection head that can eject and apply a reaction solution to a biological sample. The reaction solution is ejected from the ink jet liquid ejection head and applied to the biological sample, so that the reaction solution can be precisely applied to the biological sample.

### [Reaction Solution]

The reaction solution contains a compound capable of specifically binding to a target substance in a biological sample. The compound binds to the target substance, allowing the target substance to be brought into an identifiable state.

### (Staining Agent)

Examples of the compound capable of specifically binding to a target substance includes a staining agent for staining the target substance. As the staining agent, a staining agent commonly used in a biological sample can be used.

Examples of staining agents used for dye staining include hematoxylin, eosin, carmine, Coomassie blue, crystal violet, 2-(4-amidinophenyl)-1H-indole-6-carboxamidine (DAPI), ethidium bromide, acid fuchsin, malachite green, methyl green, methylene blue, Nile blue, Nile red, rhodamine, and safranine. In addition, staining agents used in various types of staining, such as periodic acid-Schiff (PAS) staining, Gram staining, and Giemsa staining, can also be used.

Further, examples of staining agents used for immunostaining include antibodies, such as anti-immunoglobulin (Ig), anti-IgG, anti-IgM, anti-IgA, and anti-IgE. An antibody bound to an enzyme, such as peroxidase and alkaline phosphatase, and an antibody labeled with biotin, a magnetic particle, or a fluorescent molecule can also be used. Antibody fragments, such as a papain digested fragment antigen-binding region (Fab) fragment and a pepsin digested F(ab′)2 fragment can also be used. As a staining substrate, when a labeled antibody is, for example, peroxidase, diaminobenzidine is used. Protease and a blocking agent used in a pretreatment can also be used.

Examples of staining agents used in in situ hybridization include a deoxyribonucleic acid (DNA) probe and a ribonucleic acid (RNA) probe, which are used as probes. A probe labeled with a fluorescent molecule, digoxigenin, or dinitrophenyl can also be used. Further, an anti-digoxigenin antibody, an anti-dinitrophenyl antibody, and a peroxidase conjugated antibody that binds to an anti-digoxigenin antibody can also be used. As a staining substrate, when a labeled antibody is, for example, peroxidase, diaminobenzidine is used. Protease and a blocking agent used in a pretreatment can also be used.

When the target substance is made detectable using a plurality of antibodies and a staining substrate as staining agents, a plurality of reaction solutions can be used. For example, when a primary antibody, a secondary antibody, and a staining substrate are used, the target substance can be made detectable using a first reaction solution containing the primary antibody, a second reaction solution containing the secondary antibody, and a third reaction solution containing the staining substrate. Further, when a plurality of reaction solutions is used, it is sufficient that one of the reaction solutions contains a compound capable of specifically binding to the target substance. In this case, the reaction solution that does not contain a compound capable of specifically binding to the target substance contains a compound capable of binding to a compound capable of specifically binding to the target substance. For example, in the reaction solution containing the primary antibody, the primary antibody corresponds to the compound capable of specifically binding to the target substance. Then, in the reaction solution containing the secondary antibody, the secondary antibody corresponds to the compound capable of specifically binding to the primary antibody. Further, in the reaction solution containing the staining substrate, the staining substrate corresponds to the compound capable of specifically binding to the secondary antibody.

Further, the reaction solution can also be used for multiple staining, in which a biological sample stained by an immunostaining reaction is further subjected to other staining to be compositely evaluated. In the case of multiple staining, two or more reaction solutions each contain a compound capable of specifically binding to a different target substance.

### (Aqueous Medium)

The reaction solution desirably contains an aqueous medium. The aqueous medium desirably contains water. As the water, it is desirable to use deionized water or ion-exchanged water. The water content (mass %) in the reaction solution is desirably between 25.0 mass % and 99.0 mass % based on the total mass of the reaction solution.

Further, the aqueous medium desirably contains a water-soluble organic solvent together with the water in order to improve the staining property and shorten the staining time. Here, a water-soluble organic solvent is an organic solvent of which the solubility in water at 20° C. is 200 g/L or more. The content (mass %) of the water-soluble organic solvent is desirably 75.0 mass % or less based on the total mass of the reaction solution.

Examples of water-soluble organic solvents include alcohols, (poly) alkylene glycols, glycol ethers, nitrogen-containing compounds, and sulfur-containing compounds.

Further, a water-soluble organic compound that is solid at 25° C. and dissolved in water can be used as the aqueous medium. Examples of water-soluble organic compounds that are solid at 25° C. include urea and its derivative, polyethylene glycol having an average molecular weight of 1000 or more, trimethylolpropane, and trimethylolethane.

### (Buffer Solution)

The reaction solution desirably contains a buffer solution. With a buffer solution in use, the change in pH of the reaction solution is reduced, stabilizing the staining property. Examples of buffer solutions include a phosphate buffer solution, a glycine buffer solution, a Good's buffer solution, a Tris buffer solution, and an ammonia buffer solution. Further, with the buffer solution containing an aqueous medium, the aqueous medium is considered to be a part of the aqueous medium in the reaction solution.

### (Salt)

The reaction solution can include a salt. The staining condition can be optimized by adjusting the salt concentration in the reaction solution. Examples of salts include a sodium salt, such as sodium chloride, a potassium salt, such as potassium chloride, and a magnesium salt, such as magnesium chloride.

### (Other Components)

In addition to the above-described components, the reaction solution can contain various additives, as appropriate, such as a defoaming agent, a surface active agent, a pH adjuster, a viscosity modifier, a rust-preventing agent, an antiseptic agent, a mildew-proofing agent, an antioxidant, a reduction inhibitor, and a chelating agent.

### <Specific Example of Biological Sample Preparation and Target Substance Identification Method>

A specific example of the biological sample preparation and the target substance identification method will be described.

A pretreatment can be performed on a biological sample to bring the sample into an identifiable state. For example, a biological sample can be thinly sliced to make it easier to identify. At this time, an embedding agent, such as paraffin, can be used to make it easier to thinly slice the biological sample. A method for identifying a target substance will be described using a method for identifying a target substance in a thinly sliced biological sample embedded in paraffin in immunostaining as an example.

From a biological sample embedded in paraffin, the embedding agent is removed in advance to expose the biological sample for identification, such as staining. An organic solvent used to remove the embedding agent can be xylene or ethanol. If necessary, further treatments, such as an antigen activation treatment, a protease treatment, and a blocking treatment, can be performed.

The biological sample from which the embedding agent is removed is placed on the substrate, and the contour of the biological sample on the substrate is determined. Then, the holding portion is formed by both the first liquid composition and the second liquid composition being applied along the contour of the biological sample based on information regarding the contour of the biological sample.

After the holding portion is formed, the first reaction solution containing a primary antibody that binds to an antigen, which is the target substance in the biological sample, is dispensed, and after a desired time has elapsed, a washing treatment is performed. Subsequently, the second reaction solution containing a peroxidase conjugated secondary antibody is dispensed to cause a reaction for binding the primary antibody and the secondary antibody, and then a washing treatment is performed. Further, the third reaction solution containing diaminobenzidine serving as a staining agent is dispensed to cause the secondary antibody to react with the staining agent, and then a washing treatment is performed. If necessary, counterstaining is performed using a hematoxylin solution, and then a washing treatment is performed.

After the target substance is stained as described above, the biological sample is checked through observation under a microscope. If necessary, the specimen can be checked after an enclosing operation.

The method of preparing a biological sample for an assay and the method for identifying a target substance according to the exemplary embodiment of the present disclosure is not limited to the above-described immunostaining. The method according to the exemplary embodiment of the present disclosure can also be applied to staining using a dye, such as hematoxylin and eosin (HE) staining and staining using DNA and RNA, such as in situ hybridization. Further, when it is desired to use a plurality of methods for identifying target substances together, the methods can be performed by creating a plurality of holding portions.

### [Drying Prevention Film Forming Apparatus]

The biological sample preparation apparatus desirably further includes a drying prevention film forming apparatus (hereinbelow, also referred to as a “film forming apparatus”) as a drying prevention film forming unit. The film forming apparatus forms a drying prevention film to cover the surface of a biological sample to which a reaction solution is applied in order to prevent drying of the reaction solution after the process of applying the reaction solution to the biological sample and binding the compound to the target substance. When the reaction solution contains a volatile solvent, in some cases, the contact of the reaction solution with the solvent is made inefficiently due to volatilization of the solvent. As a countermeasure against this, it is desirable to form a drying prevention film using the film forming apparatus after applying the reaction solution to the biological sample, since the film can prevent the reaction solution from drying.

There is no particular limitation on the film forming apparatus as long as the film forming apparatus can form a drying prevention film at the surface of the biological sample to which the reaction solution is applied. For example, a liquid application apparatus that can apply a liquid substance as droplets using, for example, spray, shower, dispenser, and an ink jet method, can be used. Further, when the film forming apparatus is a liquid application apparatus, the amount of a liquid substance applied to form a drying prevention film can be adjusted. For example, the amount of a liquid substance applied can be adjusted through adjustments of the diameter and the number of nozzles used to apply the liquid substance and the pressure applied to the liquid substance. Further, when the liquid application apparatus includes an electrical control unit, the amount of a liquid substance applied can be adjusted through opening and closing of the flow path of the liquid substance for forming a drying prevention film. The amount of a liquid substance applied for forming a drying prevention film can be controlled in accordance with information based on a temperature and a pressure and an external input.

There is no particular limitation on the drying prevention film as long as the drying prevention film can prevent drying of a reaction solution. For example, the drying prevention film may be formed of a liquid substance. Examples of liquid substances used to form a drying prevention film include a long-chain fatty acid, a long-chain alcohol, a mineral oil, a silicon oil, and phospholipid. The liquid substance desirably has a volatilization rate slower than that of the reaction solution, and specifically, and is desirably a long-chain fatty acid or a long-chain alcohol having a large number of carbon atoms in the compound. Examples of long-chain fatty acids include oleic acid and stearic acid. Further, examples of long-chain alcohols include behenyl alcohol and stearyl alcohol. The liquid substance can be a volatile substance, in which case it is desirable that the vapor pressure of the liquid substance be less than the vapor pressure of the solvent in the reaction solution. In order to adjust the surface tension of a liquid substance used to form a drying prevention film, a surface active agent can be used together with the liquid substance.

### <Target Substance Identification Apparatus>

The contour determination unit, the liquid ejection unit, and the reaction solution application unit included in the target substance identification apparatus can be similar to those of the biological sample preparation apparatus. Thus, the descriptions of the contour determination unit, the liquid ejection unit, and the reaction solution application unit will be omitted. A detection apparatus as the identification unit included in the target substance identification apparatus will now be described.

### [Detection Apparatus]

The target substance identification apparatus includes a detection apparatus that detects the target substance bound to a compound capable of specifically binding to the target substance. The compound capable of specifically binding to a target substance binds to the target substance, bringing the target substance into a detectable state. The detectable target substance can be detected visually, but it is desirable to use the detection apparatus in order to quantitatively detect the target substance.

There is no particular limitation on the detection apparatus, and a known detection apparatus can be used. Specifically, an optical microscope and a fluorescent microscope can be used.

According to an aspect of the present disclosure, a method of preparing a biological sample for an assay, a biological sample preparation apparatus for an assay, a target substance identification method, and an identification apparatus can be provided that can reduce an amount of a reaction solution applied to identify a target substance in a biological sample.

### EXAMPLES

The present exemplary embodiment will be described in further detail using examples and a comparative example. The present disclosure is not limited to the following examples at all as long as the example does not depart from the scope of the disclosure.

The preparation apparatus having the identification apparatus 100 illustrated in FIG. 1 and a detection apparatus was used to prepare a biological sample and to detect a target substance in a biological sample. A modified ink jet recording apparatus including an ink jet liquid ejection head was used as the preparation apparatus 100. Instead of an ink cartridge installed in the ink jet recording apparatus, cartridges respectively containing a reaction solution for identifying a target substance and a liquid composition for forming a holding portion were attached to a carriage. In the way, the ink jet liquid ejection head was set to eject the reaction solution and the liquid composition. In addition, an image capturing sensor as a contour determination apparatus was provided to determine the contour of the biological sample. These components are controlled by a computer through a circuit board similarly to a commonly used ink jet printer.

A glass slide on which a biological sample is fixed is placed in the preparation apparatus 100 illustrated in FIG. 1, and images of the biological sample are captured using the image capturing sensor. Image capturing information regarding the contour of the captured biological sample is stored in the computer. Application patterns for the liquid composition and the reaction solution are set based on the image capturing information. There are two application patterns to be used: an application pattern I for applying the liquid composition to form the holding portion along the contour of the biological sample and an application pattern II for applying the reaction solution inside the formed holding portion (inside the contour of the biological sample).

The applications are performed in the order of these set patterns. Further, as the liquid composition, the first liquid composition and the second liquid composition are used. The first liquid composition contains a cationic resin, an alkyl ketene dimer, and an aqueous medium. The second liquid composition contains an anionic resin, an alkyl ketene dimer, and an aqueous medium. The first liquid composition and the second liquid composition are each ejected from the ink jet liquid ejection heads and brought into contact with each other on the substrate, causing a reaction between the cationic resin and the anionic resin. In this way, the holding portion (partition wall) was continuously formed to cover the periphery of the contour of the biological sample. Further, the holding portion has water repellency.

### First Example

According to a first example, a method of preparing a biological sample for an assay and a method for identifying a target substance in a case of an immunostaining reaction will be described.

A cancer marker serum human epidermal growth factor receptor (HER) 2 is used as a compound capable of specifically binding to a target substance in a biological sample.

A cultured cell (biological sample) including an HER2 antigen (target substance) is placed on a glass slide and placed in the identification apparatus. First, the contour determination apparatus 101 determines the contour of the biological sample. Next, the first liquid composition and the second liquid composition are applied in the application pattern I along the determined contour of the biological sample and dried to form the holding portion (partition wall).

Next, the first reaction solution containing an anti-HER2 primary antibody is applied to the inside of the holding portion in the application pattern II to cause the anti-HER2 primary antibody to react with the HER2 antigen in the biological sample. Then, the glass slide is washed with a buffer solution to separate the excess anti-HER2 primary antibody.

Next, the second reaction solution containing an anti-HER2 secondary antibody containing an enzyme having a catalytic function for coloring is applied to the inside of the holding portion in the application pattern II to cause the anti-HER2 secondary antibody to react with the anti-HER2 primary antibody bound to the HER2 antigen in the biological sample. Then, the glass slide is washed with a buffer solution to separate the excess anti-HER2 secondary antibody.

Next, the third reaction solution containing a substrate for coloring is applied to the inside of the holding portion in the application pattern II to cause the substrate to react with the anti-HER2 secondary antibody bound to the HER2 antigen in the biological sample. Then, the glass slide is washed with a buffer solution to separate the unreacted substrate.

The glass slide is dried and observed under an optical microscope as a detection apparatus.

The color density increases according to the amount of the HER2 antigen present, allowing the color to be quantified and positive or negative to be determined based on a known criterion for color density. Further, a precise holding portion can be formed along the contour of the biological sample using the ink jet liquid ejection head, and the amount of the reaction solution applied can be reduced.

### Second Example

According to a second example, a method of preparing a biological sample for an assay and a method for identifying a target substance in a case of in situ hybridization will be described.

A cancer marker serum HER2 is used as a compound capable of specifically binding to a target substance in a biological sample.

A cultured cell (biological sample) is placed on a glass slide and heat-denatured at 95° C. for 30 minutes to dissolve the double helix structure of DNA in the biological sample. The glass slide on which the cultured cell including the heat denatured DNA is placed is placed in the identification apparatus. First, the contour determination apparatus 101 determines the contour of the biological sample. Next, the first liquid composition and the second liquid composition are applied in the application pattern I along the determined contour of the biological sample and dried to form the holding portion (partition wall).

Next, the reaction solution containing an HER2 probe labeled with a fluorescent molecule is applied to the inside of the holding portion in the application pattern II to cause the HER2 probe to react with the heat denatured DNA in the biological sample.

During this time, the concentration of the reaction solution is changeable due to evaporation of the water, so that the reaction solution is periodically applied to prevent the concentration change. Then, the glass slide is washed with a buffer solution to separate the excess probe.

The glass slide is dried and observed under a fluorescence microscope as a detection apparatus.

The color density increases according to the amount of the HER2 antigen present in the heat denatured DNA, allowing the color to be quantified and positive or negative to be determined based on a known criterion for color density. Further, a precise holding portion can be formed along the contour of the biological sample using the ink jet liquid ejection head, and the amount of the reaction solution applied can be reduced.

### Third Example

According to a third example, instead of applying the reaction solution to prevent the concentration change in the reaction solution according to the second example, the drying prevention film forming apparatus forms an oil film as a drying prevention film on the surface of the biological sample to which the reaction solution is applied.

The color density increases according to the amount of the HER2 antigen present in the heat denatured DNA, allowing the color to be quantified and positive or negative to be determined based on a known criterion for color density. Further, a precise holding portion can be formed along the contour of the biological sample using the ink jet liquid ejection head, and the amount of the reaction solution applied can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-209048, filed Dec. 12, 2023, and No. 2024-208094, filed Nov. 29, 2024, which are hereby incorporated by reference herein in their entirety.

What is claimed is:

1. A method of preparing a biological sample for an assay, the method comprising:
determining a contour of the biological sample on a substrate;
forming a holding portion along the contour using an ink jet liquid ejection head for holding at least part of a reaction solution containing a compound capable of specifically binding to a target substance in the biological sample inside the contour on the substrate; and
applying the reaction solution to the biological sample to obtain the biological sample for the assay.

2. The method according to claim 1, wherein the contour is optically determined.

3. The method according to claim 1, wherein the holding portion is formed along and in contact with the contour.

4. The method according to claim 1, wherein the holding portion is continuously formed to surround a periphery of the contour.

5. The method according to claim 1, wherein the holding portion is formed by using a plurality of the liquid ejection heads, ejecting liquid composition containing different types of constituent materials of the holding portion from the plurality of the liquid ejection heads toward the substrate, and causing the liquid composition to come into contact with each other on the substrate.

6. The method according to claim 5, wherein the liquid composition includes first liquid composition containing a cationic resin and second liquid composition containing an anionic resin.

7. The method according to claim 1, wherein the holding portion is a partition wall that partitions a space for holding the reaction solution inside the contour.

8. The method according to claim 7, wherein a minimum height of the partition wall from a surface of the substrate is higher than a maximum height of the biological sample from the surface of the substrate.

9. The method according to claim 1,
wherein the contour is optically determined, and
wherein, in the forming the holding portion, the holding portion is formed by using a plurality of the liquid ejection heads, ejecting liquid composition containing different types of constituent materials of the holding portion from the plurality of the liquid ejection heads toward the substrate, and causing the liquid composition to come into contact with each other on the substrate.

10. The method according to claim 1, wherein the reaction solution is applied by the ink jet liquid ejection head ejecting the reaction solution toward the biological sample.

11. The method according to claim 1, further comprising forming a drying prevention film for preventing the reaction solution from drying to cover a surface of the biological sample to which the reaction solution is applied after the reaction solution is applied to the biological sample to cause the compound to bind to the target substance.

12. A biological sample preparation apparatus for an assay, the biological sample preparation apparatus comprising:
a contour determination unit configured to determine a contour of the biological sample on a substrate;
a liquid ejection unit including an ink jet liquid ejection head configured to form a holding portion for holding at least part of a reaction solution containing a compound capable of specifically binding to a target substance in the biological sample inside the contour on the substrate along the contour; and
a reaction solution application unit configured to apply the reaction solution to the biological sample to obtain the biological sample for the assay.

13. A method for identifying a target substance in a biological sample, the method comprising:
determining a contour of the biological sample on a substrate;
forming a holding portion along the contour using an ink jet liquid ejection head for holding at least part of a reaction solution containing a compound capable of specifically binding to a target substance in the biological sample inside the contour on the substrate;
applying the reaction solution to the biological sample; and
identifying the target substance by detecting the compound bound to the target substance.

14. A target substance identification apparatus that identifies a target substance in a biological sample, the target substance identification apparatus comprising:
a contour determination unit configured to determine a contour of the biological sample on a substrate;
a liquid ejection unit including an ink jet liquid ejection head configured to form a holding portion for holding at least part of a reaction solution containing a compound capable of specifically binding to a target substance in the biological sample inside the contour on the substrate along the contour;
a reaction solution application unit configured to apply the reaction solution to the biological sample; and
an identification unit configured to detect the compound bound to the target substance.
